(19) United States
(12) Patent Application Publication
(10) Pub. No.: US 2006/0025991 A1
(43) Pub. Date: Feb. 2, 2006

(54) Voice coding apparatus and method using PLP in mobile communications terminal

(75) Inventor: Chan-Woo Kim, Gyeonggi-Do (KR)

Correspondence Address: LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/186,117

(22) Filed: Jul. 20, 2005

Related U.S. Application Data
(60) Provisional application No. 60/621,590, filed on Oct. 22, 2004.
(60) Provisional application No. 60/677,046, filed on May 2, 2005.

(30) Foreign Application Priority Data
Jul. 23, 2004 (KR) 10-2004-57739

(51) Int. Cl. G10L 19/12

(52) U.S. Cl. 704/223

(57) ABSTRACT

A voice coding apparatus and method of a mobile communications terminal can embody higher compressibility and ensure high sound quality, compared with the case of using a Linear Prediction (LP) coefficient, by performing a Linear Predictive Coding (LPC) using a Perceptual Linear Prediction (PLP) coefficient.

Pursuant to 35 U.S.C. § 119(a), this application claims the benefit of earlier filing date and right of priority to Korean Patent Application No. 57739/2004, filed on Jul. 23, 2004, the content of which is hereby incorporated by reference herein in its entirety.

### BACKGROUND OF THE INVENTION

1. Field of the Invention

The present invention relates to a coding of a mobile communications terminal, and particularly, to a voice coding apparatus and method using a Perceptual Linear Prediction (PLP).

2. Background of the Related Art

As mobile communication techniques are developed, mobile communications terminals have provided data communications using numbers, characters, symbols, and the like, and multimedia communications including various image signals as well as voice communications. A plurality of terminal users receive radio channels allocated thereto from a system and transmit and receive required data using radio resources. However, the radio channels have limited bandwidths in order for the plurality of users to use the radio channels at the same time, and accordingly a data bit rate of each user is deservedly limited.

Therefore, a coding technique has been proposed for transmitting a greater amount of data using above limited data bit rate. Various methods exist as the related art voice coding technique, each of which has several advantages at a certain bit rate.

For instance, a speech coding using a generic audio coding, a Pulse Code Modulation (PCM), and an Adaptive Delta Pulse Code Modulation (ADPCM) are effectively used at a high-bit rate over 16 Kbps, and a Code Excited Linear Prediction (CELP) and other various variations are effectively used at a medium-bit rate at a range of 2.4 Kbps to 16 Kbps. In particular, a coding method using LD-CELP, CS-ACELP, VSELP and MELP and a wideband speech coding can be used at the medium-bit rate. Also, a Linear Predictive Coding (LPC), Residual Excited Linear Predictive (RELP), formants vocoder and Cepstral vocoder have many advantages at a low-bit rate at a range of 75 bps to 2.4 Kbps.

Thus, in the related art and the present invention, a method for improving the LPC among coding methods used at the low-bit rate will now be explained.

FIG. 1 illustrates a structure of the related art LPC encoder.

As illustrated in the drawing, the related art LPC encoder includes: a correlator 10 for calculating an autocorrelation value rₓ[n] of an input signal x[n]; an LP coefficient calculator 11 for calculating an LP coefficient a_{L} and a gain G by processing the autocorrelation value rₓ[n]; a V/UV determining unit 12 for determining whether the input signal x[n] is a voiced V signal or a unvoiced UV signal; a pitch calculator 13 for calculating a pitch P of the corresponding signal when the input signal x[n] is the voice V signal; a parameter coding unit 14 for outputting a bit stream by coding the LP coefficient aₙ, the gain G and the pitch P received from the LP coefficient calculator 11 and the pitch calculator 13 according to a V/UV indication bit outputted from the V/UV determining unit 12.

An operation of the related art LPC encoder having such construction will now be explained.

First, the correlator 10 autocorrelates an input signal x[n]. The LP coefficient calculator 11 processes an autocorrelation value rₓ[n] calculated by the correlator 10 so as to calculate aₙ LP coefficient an and a gain G. At this time, the V/UV determining unit 12 determines whether the input signal x[n] is a voiced V signal or a unvoiced UV signal to output a V/UV indication bit, and then outputs only the voiced V signal. The pitch calculator 13 calculates a pitch P of the voiced V signal which is outputted from the V/UV determining unit 12.

Accordingly, when the V/UV indication bit indicates the voiced V signal, the parameter coding unit 14 outputs a bit stream by coding (encoding by a low-bit rate) the LP coefficient aₙ, the gain G, and the pitch P received from the LP coefficient calculator 11 and the pitch calculator 13. Afterwards, a controller (not shown) processes the bit stream to thusly output it to a radio (wireless) unit (not shown). The radio unit converts the signal outputted from the control unit into a radio (wireless) signal and transmits the converted radio signal.

Thus, in the related art, a mobile communications terminal performs the LPC coding to transmit an audio signal by a low-bit rate. However, in the related art LPC coding, a linear predication coefficient is generally used, which does not consider human auditory sensing features. Therefore, for the related art LPC coding operated using the low-bit rate, a compression efficiency is not very high (i.e., 1200 Kbps to 2400 Kbps) and good sound quality can not be obtained.

### SUMMARY OF THE INVENTION

Therefore, an object of the present invention is to provide a voice coding apparatus and method of a mobile communications terminal capable of improving compression efficiency and sound quality by performing an LPC coding using a PLP coefficient.

To achieve these and other advantages and in accordance with the purpose of the present invention, as embodied and broadly described herein, there is provided a Linear Predictive Coding (LPC) encoder of a mobile communications terminal comprising: a Perceptual Linear Prediction (PLP) coefficient calculator for calculating a PLP coefficient and a gain by processing an input signal; a V/UV determining unit for determining whether the input signal is a voiced signal or a unvoiced signal, and thusly outputting the determination signal and the voiced signal when the input signal is the voiced signal; a pitch calculator for calculating a pitch of the input signal outputted from the V/UV determining unit; and a parameter coding unit for performing a low-bit rate coding using the PLP coefficient, the gain, and the pitch on the basis of the determination signal.

To achieve these and other advantages and in accordance with the purpose of the present invention, as embodied and broadly described herein, there is provided a low-bit rate voice coding method of a mobile communications terminal comprising: calculating a Perceptual Linear Prediction (PLP) coefficient and a gain by processing an input signal; determining whether the input signal is a voiced signal and a unvoiced signal, and thereby outputting a determination bit value and the voiced signal when the input signal is determined as the voiced signal; calculating a pitch of the input signal outputted from a V/UV determining unit; and performing a low-bit rate coding using the PLP coefficient, the gain and the pitch on the basis of the determination bit value.

Preferably, the voiced signal is a speech signal.

Preferably, the PLP coefficient has about a 7^{th} degree for a 8 kHz sampling rate.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a structure of a related art LPC encoder using an LP coefficient;

FIG. 2 illustrates an LPC encoder using a PLP coefficient according to the present invention; and

FIG. 3 illustrates sequential steps, in detail, of calculating a PLP coefficient in FIG. 2.

### DETAILED DESCRIPTION OF THE INVENTION

Reference will now be made in detail to the preferred embodiments of the present invention, examples of which are illustrated in the accompanying drawings.

The present invention provides a low-bit rate voice coding using a Perceptual Linear Prediction (PLP) capable of performing a coding of a degree (an order) lower than that of a Linear Predictive Coding (LPC) in order to perform a voice coding having high compressibility.

First, a difference between the PLP and the LP will now be explained.

The LP is classically well-known, so that a detailed derived formula therefor will not be described. The LP basically refers to obtaining a LP coefficient aₖ so that a Mean Squared Error (MSE), namely, a value of e[n] can be a minimum value according to Formula (1) as follows.

$$\underline{e} [ n ] = \underline{x} [ n ] - \hat{\underline{x}} [ n ] = {\sum }_{k = 0}^{{N}_{pred}} {a}_{k} \underline{x} [ n - k ] \qquad Formula ( 1 )$$

The obtained LP coefficient aₖ has about 8^{th} to 12^{th} degrees (orders) for a 8 kHz sampling rate. Therefore, the obtained LP coefficient aₖ is used for various coding methods (e.g., LPC, CELP, MELP, RELP, etc) using a Linear Prediction (LP), which is disclosed in more detail in Speech coding and synthesis, Amsterdam, the Netherlands: Elsevier, 1995.

The PLP was introduced on a paper of Hermansky in 1990 for the first time. The PLP uses human auditory sensing features similar to the existing Mel-Frequency Cepstral Coefficient (MFCC). Therefore, the present invention performs a low-bit rate voice coding using the PLP coefficient in stead of using the LP coefficient upon performing the LPC for a low-bit rate.

That is, the present invention obtains spectrum using the PLP coefficient. The PLP coefficient reflects a human auditory effect. Accordingly, in aspect of the MSE, a greater error may occur in the spectrum using the PLP coefficient than using the LP. However, the spectrum using the PLP coefficient may have a less error when considering the auditory effect. Also, for coefficient transmissions, in case of LPC, for a typical 8 kHz sampling rate, transmissions of about a 10^{th} degree (order) are used, but for PLP, transmissions of about a 7^{th} degree (order) are used, thus the bit rate can be lowered.

FIG. 2 illustrates a construction of an LPC encoder using the PLP coefficient according to the present invention.

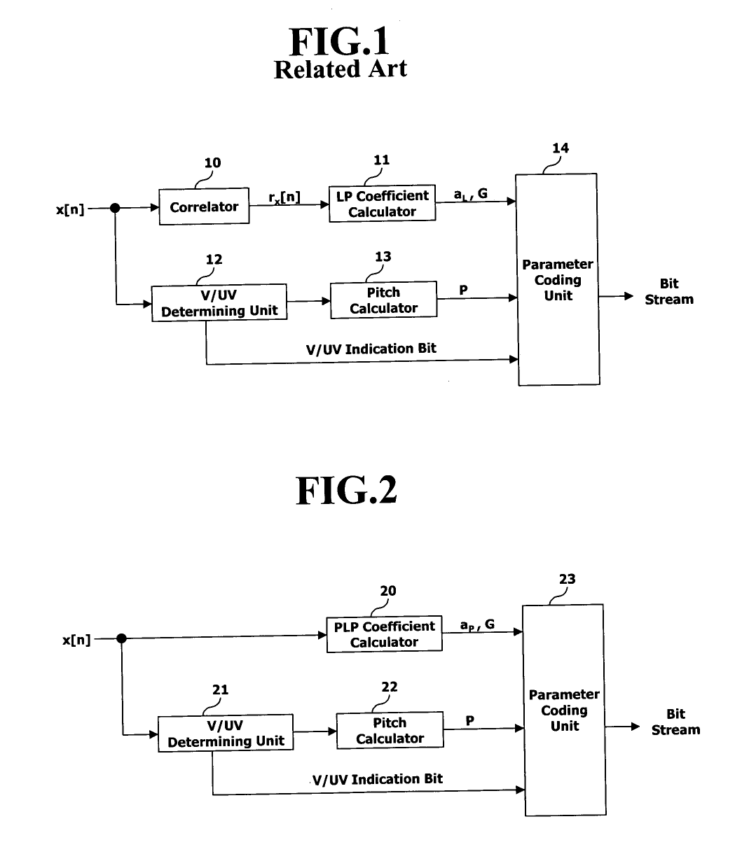

Referring to the FIG. 2, an LPC encoder using the PLP coefficient is constructed as same as the related art LPC encoder shown in FIG. 1, except of which the correlator 10 is not included and a PLP coefficient calculator 20 replaces the LP coefficient calculator 11.

The PLP coefficient calculator 20 processes a speech signal S[n] to calculate a PLP coefficient a_{P} and a gain G in which the auditory effect is considered.

An operation of the LPC encoder using the PLP coefficient having such construction according to the present invention will now be explained with reference to the accompanying drawing.

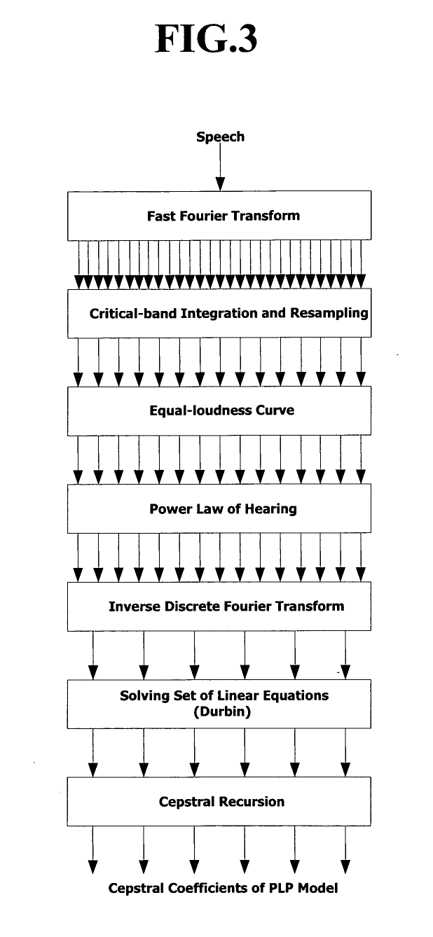

First, the PLP coefficient calculator 20 receives the speech signal S[n], so as to calculate the PLP coefficient ap and the gain G by sequentially performing operations shown in FIG. 3.

That is, the PLP coefficient calculator 20 performs a fast Fourier transform (FFT) of the input signal, namely, the speech signal S[n]. A critical-bank integration and resampling processing is performed for the Fourier-transformed speech signal to thusly remove noise components from the speech signal S[n] by a frequency unit.

Once removing the noise components, the PLP coefficient calculator 20 performs equalizing and loudness processing of the Fourier-transformed speech signal into sound components having magnitudes appropriate for human auditory sensing, and then the speech signal is matched with an output power to allow listening by humans.

When the power matching is completed, the PLP coefficient calculator 20 performs an inverse discrete Fourier transform of the corresponding speech signal to thereafter obtain a set of Linear equations from the corresponding speech signal. Therefore, the PLP coefficient calculator 20 performs a Cepstral Recursion processing for the set of Linear equations, and thus outputs Cepstral Coefficients of a PLP model, namely, the PLP coefficients ap. In other words, the PLP coefficient calculator 20 outputs to the parameter coding unit 23 a low degree (order) of the PLP coefficients ap and a gain G reflecting the human auditory sensing features as parameter values.

At this time, the V/UV determining unit 21 outputs a V/UV Indication bit and transfers the speech signal S[n] to the pitch calculator 22. The pitch calculator 22 calculates a pitch P of the speech signal S[n].

Accordingly, the parameter coding unit 23 outputs a bit stream by coding (encoding by a low-bit rate) the V/UV Indication bit value, the PLP coefficient a_{P}, the gain G and the pitch P received from the PLP coefficient calculator 20 and the pitch calculator 22. Preferably, a degree of the transmitted PLP coefficient a_{P} is about a 7^{th} degree for a 8 kHz sampling rate. Afterwards, a controller (not shown) processes the bit stream and then outputs the processed bit stream to a radio (wireless) unit (not shown). The radio unit converts the signal outputted from the controller into a radio signal (wireless signal) and transmits it.

As described above, in the present invention, the LPC is performed by using the PLP coefficient, and thus a compressibility can be improved and voice-grade signal can be transmitted by a more efficient low-bit rate.

In addition, in the present invention, a higher compressibility can be realized and a quality of signal with high sound quality can be expected by using the PLP coefficient as a parameter rather than using the existing LP coefficient.

Therefore, the voice coding apparatus and method according to the present invention can be used for coding and decoding voice using a low-bit rate, or be used for a device which takes up a small area and performs a voice synthesis using PLP parameters.

Furthermore, the voice coding apparatus and method according to the present invention can be used for a speech coding for an application as much as a voice itself is not very important but enough to hear. Also, an effective voice conversation can be performed on the Internet which stores data by a high compressibility or requires a low-bit rate in an embedded system with a limited memory.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A voice coding apparatus in a mobile communications terminal comprising:
a Perceptual Linear Prediction (PLP) coefficient calculator for calculating a PLP coefficient and a gain by processing an input signal;
a V/UV determining unit for determining whether the input signal is a voiced signal or a unvoiced signal, and thus outputting a determination results and the voiced signal when the input signal is the voiced signal;
a pitch calculator for calculating a pitch of the input signal outputted from the V/UV determining unit; and
a parameter coding unit for performing a low-bit rate coding using the PLP coefficient, the gain, and the pitch on the basis of the determination results.

2. The apparatus of claim 1, wherein the voiced signal is a speech signal.

3. The apparatus of claim 1, wherein the determination results denotes a bit value for whether the input signal is the voiced signal or the unvoiced signal.

4. The apparatus of claim 1, wherein a degree of the PLP coefficient is about a 7^{th} degree for a 8 kHz sampling rate.

5. A voice coding method of a mobile communications terminal comprising:
calculating a Perceptual Linear Prediction (PLP) coefficient and a gain by processing an input signal;
determining whether the input signal is a voiced signal and a unvoiced signal, and thereby outputting the determination signal and the voiced signal when the input signal is determined as the voiced signal;
calculating a pitch of the input signal outputted from a V/UV determining unit; and
performing a low-bit rate coding using the PLP coefficient, the gain and the pitch on the basis of the determination signal.

6. The method of claim 5, wherein the voiced signal is a speech signal.

7. The method of claim 5, wherein the step of calculating the PLP coefficient and the gain comprises:
performing a fast Fourier transform (FFT) for the input signal;
performing a critical-bank integration and resampling of the Fourier transformed speech signal to thus remove noise components by a frequency unit;
performs equalizing and loudness processing of the Fourier-transformed speech signal into sound components having magnitudes appropriate for human auditory sensing, and then matching the speech signal with an appropriate output power;
performing an inverse discrete Fourier transform of the speech signal matched with the output power, and thereby obtaining a set of linear equations; and
performing a ceptstral recursion processing for the set of linear equations, and thereby obtaining a PLP coefficient and a gain.

8. The method of claim 5, wherein a degree of the PLP coefficient is about a 7^{th} degree for a 8 kHz sampling rate.
